(19) United States
(12) Patent Application Publication
(10) Pub. No.: US 2016/0118163 A1
(43) Pub. Date: Apr. 28, 2016

(54) PRODUCTION METHOD FOR COATED STRING-SHAPED BODY

(71) Applicant: Tanabe Embroidery Co., LTD., Higashikagawa-shi, Kagawa (JP)

(72) Inventors: Tomoaki TANABE, Higashikagawa-shi, Kagawa (JP); Keisuke HASHIMOTO, Higashikagawa-shi, Kagawa (JP); Kae ASAKUNI, Higashikagawa-shi, Kagawa (JP)

(73) Assignee: Tanabe Embroidery Co., LTD., Higashikagawa-shi, Kagawa (JP)

(21) Appl. No.: 14/889,716

(22) PCT Filed: Jan. 21, 2014
(86) PCT No.: PCT/JP2014/051054

§ 371 Date: Nov. 6, 2015

(51) Int. Cl. H01B 13/22; H01B 13/34

(52) U.S. Cl. CPC H01B 13/22; H01B 13/34

(57) ABSTRACT

A method for manufacturing a covered string-like object, the method comprising a placement step of placing a string-like object on a sheet-like flexible backing, a sewing step of sewing the string-like object to the backing with an embroidery material, and a separation step of separating the backing from the string-like object. According to the method for manufacturing a string-like object, a string-like object can be easily and reliably covered with an embroidery material.

### TECHNICAL FIELD

The present invention relates to a method for manufacturing a covered string-like object, and more specifically, relates to a method for manufacturing a covered string-like object obtained by covering a string-like object such as an electrical cord with an embroidery material.

### BACKGROUND ART

Research has been conducted on enhancing the aesthetic characteristics of electrical cords such as earphone cords, power cords, and extension cords by covering such cords with cloth, thread, or the like (for example, Patent Literatures 1 and 2). A method in which cloth, string, or the like is adhered to an electrical cord, a method in which thread, leather string, or the like is wound around or sewn to an electrical cord, and like methods are known examples of specific methods for covering electrical cords.

### CITATION LIST

### Patent Literature

Patent Literature 1: JP 2011-155623A

Patent Literature 2: JP 2012-20416A

### SUMMARY OF INVENTION

### Technical Problem

However, in the case where the target of covering is a string-like object such as an electrical cord or a power cable that is repeatedly bent during use, covering methods that utilize adhesion or winding pose durability problems. On the other hand, although methods in which thread is sewn to a string-like object can enhance the aesthetic characteristics by using an embroidery thread, there is a possibility of a needle accidentally penetrating the string-like object during sewing work. Therefore, problems such as insufficient electrical conduction resulting from damaging the conductive wire of an electrical cord are likely to occur, and such methods are thus problematic in that the sewing work is likely to be troublesome.

Accordingly, an objective of the present invention is to provide a method for manufacturing a covered string-like object, capable of easily and reliably covering the string-like object with an embroidery material.

### Solution Problem

The foregoing object of the present invention is achieved by a method for manufacturing a covered string-like object, comprising:

a placement step of placing a string-like object on a sheet-like flexible backing;

a sewing step of sewing the string-like object to the backing with an embroidery material; and

a separation step of separating the backing from the string-like object.

In this method for manufacturing a covered string-like object, it is preferable that the backing is attached to one surface of a template having a cut-out hole formed in accordance with a shape of the string-like object, and it is preferable that the placement step comprises placing the string-like object on the backing via the cut-out hole.

It is preferable that the embroidery material comprises an upper thread and a lower thread, and it is preferable that the sewing step comprises performing zigzag stitching while entwining the upper thread and the lower thread on both sides of the string-like object that has been linearly placed.

The placement step may comprise placing a decoration on the backing so as to be adjacent to the string-like object; the sewing step may comprise sewing the decoration to the backing during a course of sewing the string-like object to the backing in a lengthwise direction; and the separation step may comprise separating the string-like object and the decoration from the backing.

It is preferable that the backing is composed of an easily tearable stretched film.

### Advantageous Effects of Invention

The present invention can provide a method for manufacturing a covered string-like object, capable of easily and reliably covering the string-like object with an embroidery material.

### BRIEF DESCRIPTION OF DRAWINGS

FIG. 1 is a plan view of a template used for a method for manufacturing a covered string-like object according to one embodiment of the present invention.

FIGS. 2(a) to 2(c) are diagrams showing principal steps of one example of a method for manufacturing a covered string-like object in which the template shown in FIG. 1 is used.

FIG. 3 is an enlarged view of principal parts, showing a state during the process of manufacturing a covered string-like object.

FIG. 4(a) is a cross-sectional view showing a state during the process of manufacturing a covered string-like object, and FIG. 4(b) is a cross-sectional view of a manufactured covered string-like object.

FIG. 5 is a plan view of a template used for a method for producing a covered string-like object according to another embodiment of the present invention.

FIG. 6 is an enlarged view of principal parts, showing one example of a method for producing a covered string-like object in which the template shown in FIG. 5 is used.

### DESCRIPTION OF EMBODIMENTS

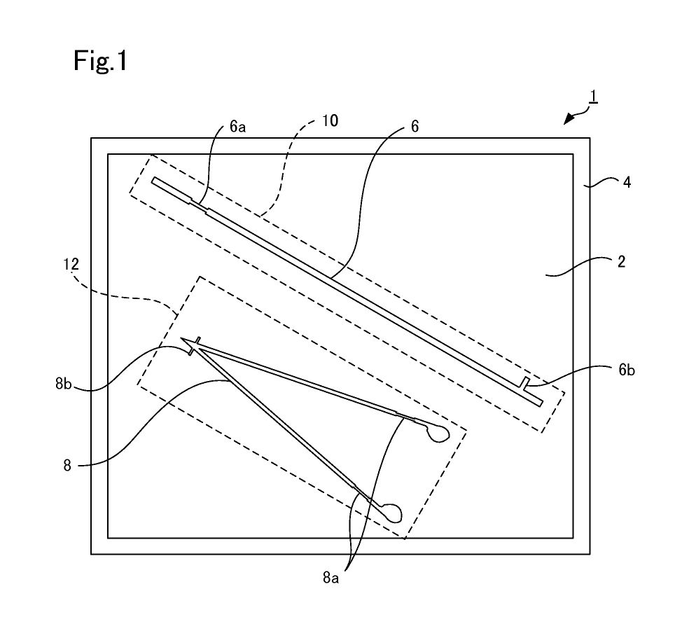

Below, embodiments of the present invention will now be described with reference to the appended drawings. FIG. 1 is a plan view of a template used for a method for manufacturing a covered string-like object according to one embodiment of the present invention. A template 1 shown in FIG. 1 is used for an earphone cord as a string-like object to be covered. The template 1 is configured such that a plate body 2 having a rectangular shape is provided within a frame 4, and the plate body 2 has two cut-out holes 6 and 8 formed in accordance with the shape of the string-like object to be covered. As indicated by the dashed lines in FIG. 1, the cut-out holes 6 and 8 are respectively covered with backings 10 and 12 attached to one surface (the back-surface side) of the plate body 2 using an easily removable adhesive or the like, and the string-like object (not shown) can be placed on the backings 10 and 12 via the cut-out holes 6 and 8.

It is preferable that the plate body 2 has such a rigidity that the plate body 2 does not deform due to the attachment of the backings 10 and 12. The plate body 2 can be formed from, for example, cardboard, a synthetic-resin plate, or a metal plate. In accordance with the overall shape of the earphone to be covered, the cut-out holes 6 and 8 are each formed so as to be able to accommodate roughly half of the earphone cord. The cut-out hole 6 can accommodate roughly a plug-side half of the earphone cord in a straightened state. The cut-out hole 8 can accommodate the bifurcated portions of the earphone cord both in a straightened state.

The cut-out hole 6 comprises a narrow holding part 6a and a slot-like insertion part 6b on the respective sides in the lengthwise direction. The distal part of the earphone cord is held by the holding part 6a, and, on the other hand, an insert (not shown) is inserted into the insertion part 6b to latch the mid part of the earphone cord, and it is thus possible to fix the earphone cord within the cut-out hole 6. As with the cut-out hole 6, the cut-out hole 8 also comprises holding parts 8a and an insertion part 8b. As long as the earphone cord can be reliably fixed within the cut-out holes 6 and 8, fixing means other than the holding parts 6a and 6b and the insertion parts 8a and 8b may be used.

The backings 10 and 12 are sheet-like components that a sewing-machine needle can penetrate, and it is preferable that the backings 10 and 12 are flexible so as to conform to the earphone cord during sewing. Examples of the material of the backings 10 and 12 include synthetic resin film, metal foil, thin paper, and the like. Since the backings 10 and 12 are eventually separated from the earphone cord, it is preferable that the backings 10 and 12 have excellent tearability, and, for example, a stretched polyethylene film or the like that is easily torn in the direction of stretch can be suitably used.

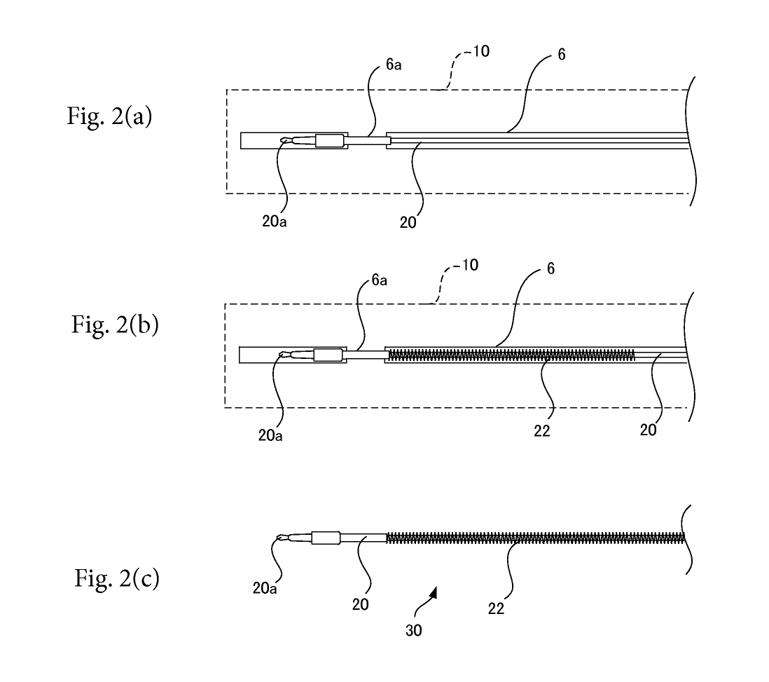

Next, a method for manufacturing a covered string-like object using the above-described template 1 will now be described with reference to FIG. 2. FIG. 2 shows partially enlarged views of the cut-out hole 6 of the template shown in FIG. 1. First, as shown in FIG. 2(a), the plug 20a side of the earphone cord 20 in a straightened state is accommodated inside the cut-out hole 6, the proximal part of the plug 20a is held by the holding part 6a, and also the side of the earphone cord 20 at the center is fixed at the insertion part 8b shown in FIG. 1. In this way, the earphone cord 20 is positioned on the backing 10 via the cut-out hole 6.

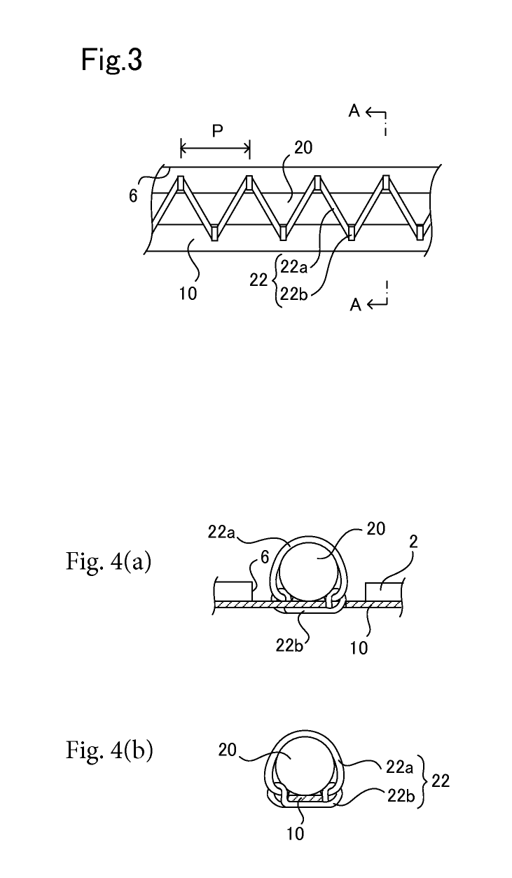

Subsequently, this template 1 is placed on an automatic sewing machine (not shown), and as shown in FIG. 2(b), a section of the earphone cord 20 from the plug 20a side to near the center is sewn to the backing 10 with a sewing material 22. As shown in the enlarged view of FIG. 3, the sewing material 22 is composed of an upper thread 22a and a lower thread 22b, and a sewing-machine needle is caused to penetrate the backing 10 on both sides of the earphone cord 20 to entwine the upper thread 22a and the lower thread 22b by way of zigzag lockstitching, and thus the upper thread 22a is disposed in a zigzag manner so as to cover the earphone cord 20 on the front-surface side of the backing 10. On the back-surface side of the backing 10, the lower thread 22b is disposed in a zigzag manner. A pitch p of the zigzag pattern of the upper thread 22a is emphasized in FIG. 3 so as to appear large, but, practically, it is preferable that the upper thread 22a is sewn at such a small pitch p that the earphone cord 20 is not exposed. It is also possible to entwine the upper thread 22a and the lower thread 22b in such a way that one thread forms a zigzag pattern, and the other thread linearly extends along the earphone cord 20.

As shown in FIG. 4(a), the place where the upper thread 22a and the lower thread 22b are entwined may be above (on the front-surface side of) the backing 10, and, also, it may be in the interior of the backing 10 or below (on the back-surface side of) the backing 10 as well. The thread tension can be suitably adjusted. An embroidery thread can be suitably used as the embroidery material 22, thus making it possible to enhance the aesthetic characteristics by taking advantage of its color, luster, etc. The embroidery material 22 may be a string-like or belt-like embroidery material other than a thread-like material. The embroidery material 22 may be intended primarily for textural, anti-allergic, or like purposes other than aesthetic purposes.

After about half of the earphone cord 20 is sewn to the backing 10 with the embroidery material 22 in this way, the rest of the earphone cord 20 is sewn to the backing 10 with the embroidery material 22 in the same manner as above by using the cut-out hole 8 shown in FIG. 1. In this way, substantially all the earphone cord 20 can be sewn to the backing 10.

Thereafter, the earphone cord 20 is removed from the template 1 to separate the backing 10 from the earphone cord 20 as shown in FIG. 4(b), and, thereby, the entire outer circumference of the earphone cord 20 is covered with the upper thread 22a and the lower thread 22b, and, as shown in FIG. 2(c), it is thus possible to obtain the covered string-like object 30 in which the earphone cord 20 is covered with the embroidery material 22. After the backing 10 is separated from the earphone cord 20, there may be a slight remainder of the backing 10 between the earphone cord 20 and the embroidery material 22 (see FIG. 4(b)). Forming the zigzag pattern of the embroidery material 22 at a small pitch makes it possible to prevent the remaining backing 10 from being exposed to the outside and adversely affecting the appearance. Thereafter, the backing 10 (12) remaining on the template 1 is removed, then a new backing 10 (12) is attached, and it is thus possible to used the template 1 again.

As described above, according to the method for manufacturing a covered string-like object of the present embodiment, the earphone cord 20 is sewn to the backings 10 and 12 with the embroidery material 22, and then the backings 10 and 12 are separated from the earphone cord 20. It is therefore possible to easily and reliably cover the earphone cord 20 with the embroidery material 22 without damaging the earphone cord 20 with a sewing-machine needle or the like, and thus possible to obtain the covered string-like object 30 that has good durability. Moreover, the use of the template 1 on one surface of which the backings 10 and 12 have been attached makes it possible to more easily manufacture the covered string-like object 30.

One embodiment of the present invention has been described in detail above, but the specific aspects of the present invention are not limited to the above embodiment. For example, the above embodiment has been described using an earphone cord as an example of a target to be covered with an embroidery material, but other string-like objects may be used as well, such as power cords, extension cords, and like electrical cords, and cables.

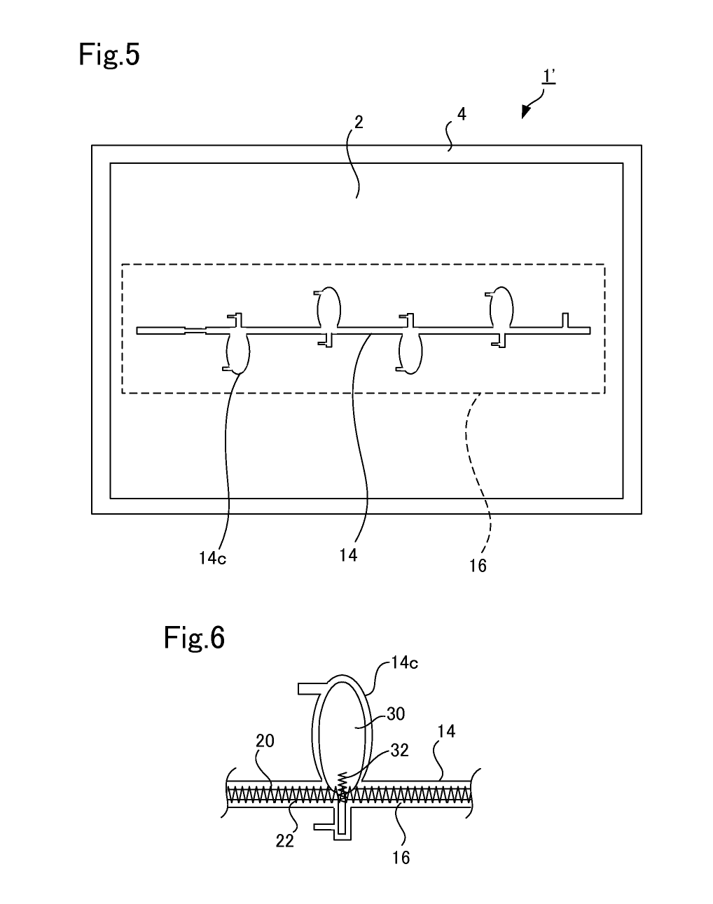

Moreover, as shown in FIG. 5, one or more decorative parts 14c may be formed by making slots that are in communication with a linear cut-out hole 14 formed in a template 1′, such that a backing 16 is attached so as to cover the cut-out hole 14 and the decorative parts 14c. As shown in FIG. 6, with this template 1′, the string-like object 20 such as an earphone cord is placed in the cut-out hole 14, a decoration 30 (such as a leaf or a flower of a plant) is placed in the decorative parts 14c, and the decoration 30 can be sewn to the backing 10 with an embroidery material 32 during the course of sewing the string-like object 20 to the backing 10 with the embroidery material 22 in the lengthwise direction. The embroidery materials 22 and 32 may be the same or may be different. Thereafter, the backing 10 is separated from the string-like object 20 and the decoration 30, and it is thus possible to obtain a covered string-like object having enhanced aesthetic characteristics. In FIG. 5, the same components as in FIG. 1 are given the same reference numbers.

### REFERENCE SIGNS LIST

1 Template
2 Plate body
4 Frame
6, 8 Cut-out holes
10, 12 Backings
20 Earphone cord (String-like object)

1. A method for manufacturing a covered string-like object, the method comprising:
a placement step of placing a string-like object on a sheet-like flexible backing;
a sewing step of sewing the string-like object to the backing with an embroidery material; and
a separation step of separating the backing from the string-like object.

2. The method for manufacturing a covered string-like object according to claim 1, wherein
the backing is attached to one surface of a template having a cut-out hole formed in accordance with a shape of the string-like object; and
the placement step comprises placing the string-like object on the backing via the cut-out hole.

3. The method for manufacturing a covered string-like object according to claim 1, wherein
the embroidery material comprises an upper thread and a lower thread; and
the sewing step comprises performing zigzag stitching while entwining the upper thread and the lower thread on both sides of the string-like object that has been linearly placed.

4. The method for manufacturing a covered string-like object according to claim 1, wherein
the placement step comprises placing a decoration on the backing so as to be adjacent to the string-like object;
the sewing step comprises sewing the decoration to the backing during a course of sewing the string-like object to the backing in a lengthwise direction; and
the separation step comprises separating the string-like object and the decoration from the backing.

5. The method for manufacturing a covered string-like object according to claim 1, wherein the backing is composed of an easily tearable stretched film.
